(19) United States
(12) Patent Application Publication
(10) Pub. No.: US 2008/0314264 A1
(43) Pub. Date: Dec. 25, 2008

(54) Device For Pressing On Semiconductor Chips Arranged On A Substrate

(75) Inventor: Roland Kuster, Urdorf (CH)

Correspondence Address: THELEN LLP, P. O. BOX 640640, SAN JOSE, CA, 95164-0640, US

(73) Assignee: OERLIKON ASSEMBLY EQUIPMENT AG, STEINHAUSEN, Cham (CH)

(21) Appl. No.: 12/143,585

(22) Filed: Jun. 20, 2008

(30) Foreign Application Priority Data
Jun. 22, 2007 (CH) 1016/07

(51) Int. Cl. B30B 1/00

(52) U.S. Cl. 100/179

(57) ABSTRACT

A device for pressing on semiconductor chips situated on a substrate comprises a substrate support and a tool movable in relation to the substrate support in a predetermined movement direction, which has multiple pressing plungers mounted so that they are displaceable in the movement direction of the tool for pressing on the semiconductor chips. The tool has a pressure chamber to which compressed air may be applied. All pressing plungers are situated along a straight line. Each of the pressing plungers has a bar running perpendicularly to the movement direction of the tool and perpendicularly to the cited straight line on its end facing toward the pressure chamber. Pistons are situated in the area between the pressure chamber and the pressing plungers, which are displaceable in the movement direction of the tool. One side of the pistons is subjected to the pressure existing in the pressure chamber and the other side rests on one of the bars of the pressing plungers.

### PRIORITY CLAIM

Applicant hereby claims foreign priority under 35 U.S.C §119 from Swiss Application No. 1016/07 filed Jun. 22, 2007, the disclosure of which is herein incorporated by reference.

### FIELD OF THE INVENTION

The invention concerns a device for pressing on semiconductor chips arranged on a substrate.

### BACKGROUND OF THE INVENTION

Semiconductor chips are mounted in many cases using a mounting machine, which is known in the technical world as a die bonder. Such mounting machines are known, for example, from EP 923111, EP 1480507, and WO 97/32460. The semiconductor chips are provided on a wafer table on a film retained on a frame and then glued to a substrate using an epoxy adhesive or a tape. Such tapes are typically not sticky. They first develop their adhesive capability in the course of the mounting process under the influence of pressure and heat. The wafer table is displaced cyclically, so that one semiconductor chip after another is provided at a first location. The provided semiconductor chip is then picked up by the bonding head of the mounting machine, placed on a substrate, and pressed against the substrate during a specific duration τ. The substrate having the glued-on semiconductor chips is subsequently subjected to an elevated temperature in a furnace to cure the adhesive. The duration τ which is necessary to implement an optimum adhesive layer between the semiconductor chip and the substrate is a function of various factors, but increases with increasing size of the semiconductor chip. The longer the required duration τ, the longer the mounting cycle and thus the lower the throughput of the mounting machine. Therefore, mounting methods have been developed in which the exact placement of the semiconductor chip on the substrate and the final bonding under high pressure and at high temperature no longer is performed in one step at a single processing station, but rather in separate steps at two processing stations. Such methods are known from JP 11121532, EP 1030349 and EP 1204137.

In JP 11-121532 multiple electronic components of different constructions situated on a substrate may be pressed on simultaneously using a single tool. The tool has multiple individual pressing plungers for this purpose, which are mounted so they are displaceable in the pressing direction in a guide and each of which may be impinged individually using a separately activatable hydraulic or pneumatic cylinder.

In EP 1030349 multiple pressing plungers are mounted in a tool so they are displaceable in the pressing direction. The pressing force is transmitted via a diaphragm mounted on a liquid, i.e., using hydrostatic pressure, to the pressing plungers.

The method of EP 1204137 is only suitable for specific applications, namely for mounting so-called flip chips on a flexible substrate.

### SUMMARY OF THE INVENTION

The invention is based on the object of developing a device for pressing on semiconductor chips situated on a substrate, in which the force for pressing on the semiconductor chips is transmitted pneumatically, the pressure source having to deliver at most 4 bar.

A device according to the invention for pressing on semiconductor chips situated on a substrate comprises a substrate support and a tool movable in relation to the substrate support in a predetermined movement direction. The tool has multiple pressing plungers mounted so that they are displaceable in the movement direction of the tool for pressing on the semiconductor chips. The tool further has a pressure chamber to which compressed air may be applied. The pressing plungers are situated along a straight line. Each of the pressing plungers has on its end facing toward the pressure chamber a bar running perpendicularly to the movement direction of the tool and perpendicularly to the cited straight line. Pistons, which are displaceable in the movement direction of the tool, are situated in the area between the pressure chamber and the pressing plungers. One side of the pistons is subjected to the pressure existing in the pressure chamber and the other, opposite side rests on one of the bars of the pressing plungers. There is at least one bar on which at least two of the pistons rest. With this solution, the force exerted by the pistons via the bars on the pressing plungers may be pneumatically generated, in spite of the usually small distance between adjacent semiconductor chips.

### BRIEF DESCRIPTION OF THE DRAWING FIGURES

The accompanying drawings, which are incorporated into and constitute a part of this specification, illustrate one or more embodiments of the present invention and, together with the detailed description, serve to explain the principles and implementations of the invention. The figures are not to scale. In the drawings:

FIG. 1 shows a device for pressing on semiconductor chips situated on a substrate in a first section,

FIG. 2 shows the device in a second section, which runs perpendicular to the section of FIG. 1,

FIGS. 3 and 4 show the device in a perspective view, and

FIGS. 5 to 7 show certain details of the device.

### DETAILED DESCRIPTION OF THE INVENTION

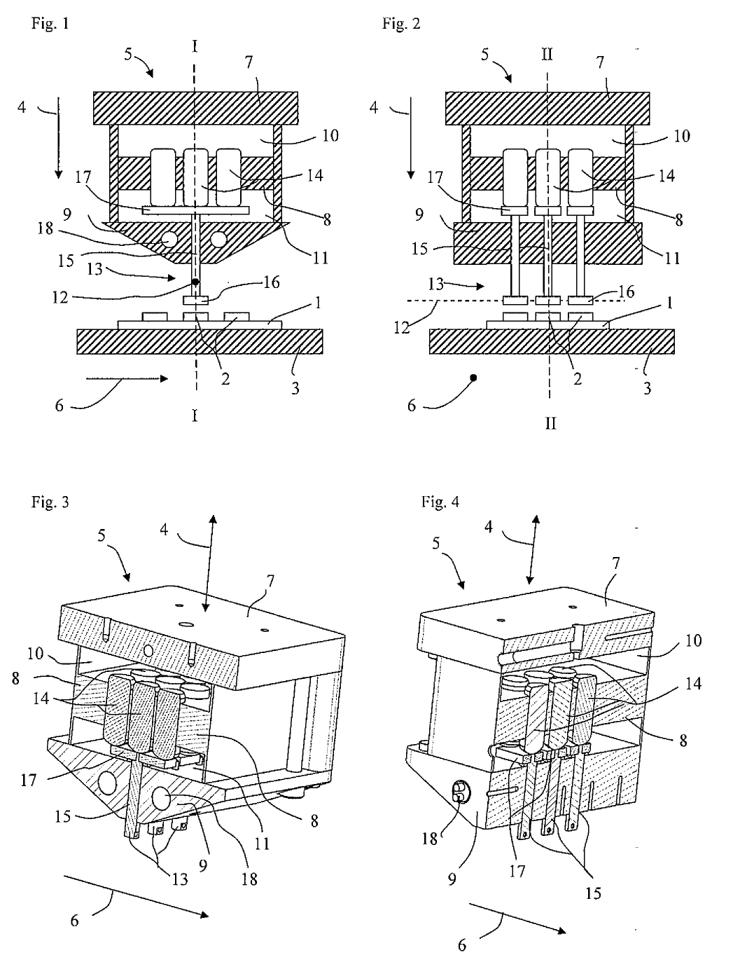

FIG. 1 shows a lateral view of the parts necessary for understanding the invention of a device for pressing on semiconductor chips 2 situated on a substrate 1. The device comprises a substrate support 3 and a tool 5 movable in relation to the substrate support 3 in a predetermined movement direction 4. In this example, the substrate support 3 is situated stationary and the tool 5 is movable toward the substrate support 3. Alternatively, however, the tool 5 may be situated stationary and the substrate support 3 may be movable toward the tool 5. The substrates 1 are transported cyclically by a transport device (not shown) in a transport direction 6 shown by an arrow toward the substrate 3. The tool 5 essentially comprises a cover part 7, a middle part 8, and a head part 9, which are connected to one another by walls and/or spacers, a pressure chamber 10, to which compressed air may be applied, being formed between the cover part 7 and the middle part 8, and a chamber 11 which is closed or open to the surroundings in regard to pressure being formed between the middle part 8 and the head part 9. The head part 9 has multiple pressing plungers 13 which are mounted so they are displaceable in the movement direction 4 of the tool 5 for pressing the semiconductor chips 2 onto the substrate 1. All pressing plungers 13 are situated adjacent to one another along a straight line 12. The straight line 12 runs perpendicular to the transport direction 6 of the substrate 1 and perpendicular to the movement direction 4 of the tool 5 in this example, because of which only a single pressing plunger 13 is visible in FIG. 1. The middle part 8 has multiple pistons 14 which are mounted so they are displaceable in the movement direction 4 of the tool 5. Each of the pressing plungers 13 comprises a shaft 15, one end of which is implemented as a pressing surface or on one end of which a pressing head 16 is fastened as shown. The pressing head 16 is preferably fastened in such a manner that it is rotatable around two axes perpendicular to the movement direction 4 of the pressing plunger 13, so that it automatically adapts itself to a possible inclined position of the semiconductor chip 2 when pressing on the semiconductor chip 2. A bar 17 running perpendicular to the movement direction 4 of the tool 5 and perpendicular to the cited straight line 12 is fastened to the end of the shaft 15 facing toward the pressure chamber 10. The bars 17 of all pressing plungers 13 thus run parallel to the transport direction of the substrate 1 in this example. The one end of the piston 14 is subjected to the pressure existing in the pressure chamber 10, the other end of the piston 14 rests on one of the bars 17. There is at least one bar 17 on which rest at least two of the pistons 14. Therefore, at least one piston 14 is assigned to each pressing plunger 13, which transmits the pressure existing in the pressure chamber 10 to the assigned pressing plunger 13.

FIG. 2 shows the device in a section along line I-I of FIG. 1. FIG. 1 in turn shows a section along line II-II of FIG. 2. The device contains three pressing plungers 13 in this example, which are visible together with their bars 17 in the sectional view of FIG. 2. However, only one piston 14 is visible per pressing plunger 13. The device may also contain more than three pressing plungers 13.

The bars 17 of the pressing plungers 13 are located in the chamber 11, in which preferably the same pressure exists as in the surroundings. The pistons 14 seal the chamber 11 in relation to the pressure chamber 10. The pistons 14 preferably consist of steel. The steel used should have good friction properties. On the other hand, the pistons 14 may be manufactured from an arbitrary steel, if their surface is coated with a layer made of a material having good friction properties, such as a so-called DLC (diamond-like coating) coating or a MoS₂ coating. A suitable DLC coating is known under the trade name Balinit®. Heating cartridges 18 are integrated in the head part 9, preferably two, which are housed on both sides of the shafts 15 of the pressing plungers 13. The heating cartridges 18 are used to heat the pressing plungers 13 to a predetermined temperature.

FIGS. 3 and 4 show perspective views of half of the tool 5, the tool 5 being sectioned in the middle in each case. FIG. 3 illustrates the state of affairs shown in FIG. 1, FIG. 4 illustrates the state of affairs shown in FIG. 2. The pistons 14 are preferably rounded on the side facing toward the bar 17, as shown in FIGS. 3 und 4, so that the contact surface between the piston 14 and the bar 17 is relatively small, namely approximately a punctual contact. In this way, little heat is transferred from the hot pressing plunger 13 to the piston 14. Additional cooling of the piston 14 results because, due to the pressure difference between the overpressure existing in the pressure chamber 10 and the pressure existing in the chamber 11, some air always flows through the air gap between the tool 5 and the piston 14. The leakage rate is not zero. In order that the piston 14 mounted in the middle part 8 may always slide back and forth well even at different operating temperatures of the head part 9 of the tool 5, the coefficients of expansion of the material used for the metal part 8 and the material used for the piston 14 are to be as equal as possible. To make the transfer of heat from the head part 9 to the middle part 8 as difficult as possible, the walls delimiting the chamber 11 are advantageously provided with openings, so that they only form a three-point contact with the processing head 16, and are manufactured from a material which conducts heat poorly, such as ceramic for example.

The device is suitable for pressing semiconductor chips 2 onto a substrate 1, which are situated in columns running perpendicularly to the transport direction 6 of the substrate. Each column contains a predefined number of semiconductor chips 2 and the device an equal number of pressing plungers 13. The device is used in particular if the semiconductor chips are fastened to the substrate using a tape. The tool 5 is moved in relation to the substrate support 3, the substrate support 3 being situated stationary in this example. The mode of operation of the device is as follows:
1. The tool 5 is located in a raised position. A predetermined pressure is applied to the pressure chamber 10. The pressure existing in the pressure chamber 10 presses the pistons 14 against the bars 17, so that the bars 17 rest on the head part 9. The head part 9 is heated to a predetermined temperature.
2. The substrate is advanced in the transport direction 6, so that a column having semiconductor chips 2 is located on the substrate support 3 below the pressing plungers 13. 3. The tool 5 is lowered in the movement direction 4, so that it is located in a lowered position. This position is selected in such a manner that the pressing plungers 13 come to rest on the semiconductor chips 2 and all pressing plungers 13 are deflected upward. The bars 17 now no longer rest on the head part 9. The pressure existing in the pressure chamber 10 is transmitted via the pistons 14 to the pressing plungers 13. Therefore, each pressing plunger 13 presses on the corresponding semiconductor chip 2 with equal force F. The force F is proportional to the sum of the cross-sectional areas of those pistons 14, which press on the same bar 17, and proportional to the pressure differential p₁-p₂ between the pressure p₁ existing in the pressure chamber 10 and the pressure p₂ existing in the chamber 11.

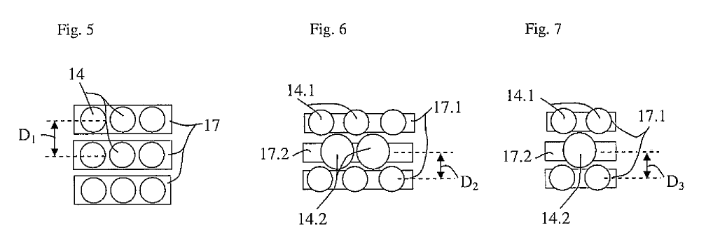

FIGS. 5 to 7 show top views of the bars 17 of three pressing plungers 13 and the pistons 14 acting on the bars 17 in three different variants. In variant 1 of FIG. 5, three pistons 14 act on each bar 17 and all pistons 14 have equal cross-sectional area. In variant 2 of FIG. 6, three pistons 14.1, whose cross-sectional area has the value A₁, act on the outside bars 17.1. Two pistons 14.2, whose cross-sectional area has the value A₂ and which are situated offset in relation to the pistons 14.1 acting on the outside bars 17.1, act on the middle bar 17.2. In this case, 3*A₁=2*A₂, so that equal force is exerted on all bars 17.1 and 17.2. In variant 3 of FIG. 7, two pistons 14.1, whose cross-sectional area has the value A₁, act on the outside bars 17.1. One piston 14.2, whose cross-sectional area has the value A₂ and which is situated offset in relation to the piston 14.1 acting on the outside bars 17.1, acts on the middle bar 17.2. In this case 2*A₁=A₂. The two variants 2 and 3 allow the distance D₂ or D₃ between adjacent bars 17 to be reduced in relation to the distance D₁ of variant 1.

The device may also be used for pressing semiconductor chips 2 onto a substrate 1, which are situated in a line running parallel to the transport direction 6 of the substrate. For this purpose, the tool is to be rotated by 90° around the movement direction 4 in relation to the preceding example.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims and their equivalents.

What is claimed is:

1. A device for pressing on semiconductor chips situated on a substrate, the device comprising a substrate support, and
a tool movable in relation to the substrate support in a predetermined movement direction, the tool comprising
a pressure chamber to which compressed air may be applied,
a multiplicity of pressing plungers situated along a straight line, each pressing plunger for pressing on an individual semiconductor chip, each pressing plunger bearing in the tool displaceably in the movement direction of the tool, each pressing plunger having on an end facing toward the pressure chamber a bar running perpendicular to the movement direction of the tool and perpendicular to said straight line, and
a multiplicity of pistons situated between the pressure chamber and the pressing plungers, the pistons displaceable in the movement direction of the tool, wherein one side of each piston is subjected to a pressure existing in the pressure chamber and an opposite side of each piston rests on one of the bars of the pressing plungers, wherein there is at least one bar on which at least two of the pistons rest.

2. The device according to claim 1, wherein the pistons are rounded on a side facing toward the bars.
